(19) United States
(12) Patent Application Publication
(10) Pub. No.: US 2006/0099546 A1
(43) Pub. Date: May 11, 2006

(54) Upper and a lower single preformed and/or customized appliance and a method for attaching the appliance to a first area of a dentition and moving teeth at a second area of the dentition

(76) Inventor: Earl O. Bergersen, Dorado, PR (US)

Correspondence Address: PATENTS+TMS, P.C., 2849 W. ARMITAGE AVE., CHICAGO, IL, 60647, US

(21) Appl. No.: 11/257,330

(22) Filed: Oct. 24, 2005

Related U.S. Application Data
(60) Provisional application No. 60/626,604, filed on Nov. 10, 2004.

(51) Int. Cl. A61C 3/00

(52) U.S. Cl. 433/6

(57) ABSTRACT

An upper orthodontic appliance and/or a lower orthodontic appliance are provided for attaching to teeth in a mouth of a patient and/or straightening the teeth of the patient. The upper appliance and/or the lower appliance have a first area and/or a second area. The first area attaches to a first area of a dentition of the patient. The second area moves the teeth at a second area of the dentition of the patient. The upper appliance and/or the lower appliance have a single slot, sockets or a combination of both the slot and the sockets therein. The upper appliance and/or the lower appliance may be preformed, customized to receive the teeth of the patient or preformed and customized to receive the teeth of the patient. The upper appliance and/or the lower appliance move one or more teeth of the patient to correct an orthodontic condition of the patient. A wire is insertable into the upper appliance and/or the lower appliance. The wire bends to expand or to constrict the upper appliance and/or the lower appliance. As a result, the upper appliance and/or the lower appliance may abut an arch of the upper jaw and/or an arch of the lower jaw in a mouth of the patient to correct jaw misalignment in the mouth of the patient.

This application claims the benefit of U.S. Provisional Application Ser. No. 60/626,604, filed Nov. 10, 2004.

### BACKGROUND OF THE INVENTION

The present invention generally relates to an orthodontic appliance which may attach to teeth of a patient and/or may move the teeth of the patient. More specifically, the present invention relates to an upper orthodontic appliance and/or a lower orthodontic appliance that may be attached to the dentition of the patient and/or may move the teeth of the patient. The upper appliance and/or the lower appliance may have a first area to attach the appliance to a first area of the dentition of the patient. The upper appliance and/or the lower appliance may have a second area to move the teeth at a second area of the dentition of the patient. The upper appliance and/or the lower appliance may be preformed, may be customized for the patient and/or may be both preformed and customized for the patient.

It is generally known to provide dental care to a patient who may have an orthodontic condition. A care provider, such as, for example, a dentist or an orthodontist may examine the teeth and/or a mouth of the patient to determine the orthodontic condition. The dentist may then provide recommendations for treatment and/or correction of the orthodontic condition of the patient.

The mouth of the patient may have upper teeth and/or lower teeth. The mouth of the patient may include an upper jaw which may have an arch in the mouth of the patient. The upper teeth of the patient may erupt from and/or may be attached to the arch of the upper jaw. Additionally, the mouth of the patient may include a lower jaw opposite to the upper jaw of the patient. The lower jaw may have an arch. The lower teeth of the patient may erupt from and/or may be attached to the arch of the lower jaw.

The appliance may move, correct and/or straighten teeth of the patient to correct the orthodontic condition of the patient. Further, the arch of the upper jaw and/or the arch of the lower jaw in a mouth of the patient may require correcting, moving and/or straightening to correct the orthodontic condition of the patient. Further, the arch of the upper jaw and the second arch of the lower jaw may require joining or linking together to adjust a horizontal distance between the first arch and the second arch. Still further, the arch of the upper jaw and the arch of the lower jaw may require joining and/or linking together to intercuspate the upper teeth and the lower teeth. Moreover, the arch of the upper jaw and/or the arch of the lower jaw may require individual adjustments in one arch without involving the other arch, such as, for example, expansion, constriction, prevention of thumb sucking, correction of tongue thrust swallowing patterns and/or individual tooth movements.

Traditionally, appliances for moving, correcting and/or straightening the teeth of the patient fail to adjust the horizontal and/or vertical distance between the arch of the upper jaw and the arch of the lower jaw in the mouth of the patient. Additionally, appliances for straightening the teeth fail to intercuspate the upper teeth and the lower teeth of the patient. Further, appliances that attach the upper jaw to the lower jaw fail to separate the arch of the upper jaw and the arch of the lower jaw in the mouth of the patient to allow free unrestricted movement of the lower jaw in relation to the upper jaw. Moreover, appliances that correct only the upper arch or the lower arch with separate unrelated or coordinated applicances, fail to correct and/or to align and coordinate the arch of the upper jaw and the arch of the lower jaw in the mouth of the patient for proper function.

A need, therefore, exists for an improved appliance and a method for attaching the appliance to a first area of a dentition and moving teeth at a second area of the dentition. Additionally, a need exists for an improved appliance and a method for attaching the appliance to a first area of a dentition and moving teeth at a second area of the dentition which has prefabricated sockets and/or slots for one or more teeth to allow erupting teeth of the arch of the upper jaw and/or the lower to be guided into the mouth of the patient. Further, a need exists for an improved appliance and method for attaching the appliance to a first area of a dentition and moving teeth with a second area which aligns the upper jaw and the lower jaw without interfering with natural jaw movement. Moreover, a need exists for an improved appliance and method of securing the appliance to a first area of a dentition and moving teeth with a second area which has a customized socket and/or prefabricated socket and/or slot for one or more teeth to be used as a retainer to hold one or more teeth in a corrected position after moving one or more teeth.

### SUMMARY OF THE INVENTION

The present invention generally relates to an orthodontic appliance which may attach to teeth of a patient and/or may move the teeth of the patient. More specifically, the present invention relates to an upper orthodontic appliance and/or a lower orthodontic appliance which may adhere by any means, such as, for example, a reline material, a sticky surface, a glue, and/or the like to a first area of a dentition of the patient and/or may move the teeth of the patient at a second area of the dentition. The upper appliance and/or the lower appliance may have a first area and/or a second area. A first area of the upper appliance and/or the lower appliance may attach to the first area of a dentition of the patient. A second area of the upper appliance and/or the lower appliance may move one or more teeth at the second area of the dentition. The upper appliance and/or the lower appliance may have a single slot or sockets and/or slots therein for receiving one or more teeth of the patient. The upper appliance and/or the lower appliance may be, for example, preformed, customized or both preformed and customized to receive one or more teeth of the patient. The upper appliance and/or the lower appliance may move one or more teeth of the patient to a position in a mouth of the patient and/or may maintain one or more teeth of the patient in the position.

During moving, correcting and/or straightening the teeth of the patient, the upper appliance and/or the lower appliance may be secured to the mouth of the patient. The mouth of the patient may have an upper jaw and/or a lower jaw which is opposite to the upper jaw. The upper jaw may have an arch with upper teeth of the patient. The upper teeth of the patient may erupt outward, inward, forward or rearward with respect to the existing arch of the upper jaw. The lower jaw may have an arch which may have lower teeth of the patient. The lower teeth may erupt outward, inward, forward or rearward with respect to the existing arch of the lower jaw. The upper appliance may be attached to the arch of the upper jaw and/or the upper teeth of the patient. The lower appliance may be attached to the arch of the lower jaw and/or the lower teeth of the patient. As a result, the upper appliance and/or the lower appliance may correct displaced teeth in an arch and also may correct advancement and/or retrusiveness of lower jaw and/or the upper jaw, respectively. The upper appliance and the lower appliance may use the arch of the upper jaw and/or the lower jaw, respectively, as an anchorage unit. Additionally, a rear and/or a front portion of the arch of the upper jaw and/or the lower jaw may be used as the anchorage unit to secure a portion of teeth and/or to enable the upper appliance and/or the lower appliance to remain in the mouth of the user. Further, the upper appliance and/or the lower appliance may hold a front and/or a rear portion of the upper teeth, the lower teeth and/or the arch of the upper jaw and/or the lower jaw to apply a force against the teeth of the patient. As a result, the teeth may be orthodontically moved without application of an external force against the teeth.

After the teeth have been moved, the teeth may be secured in place by, for example, a stiff reline material. The upper appliance and/or the lower appliance may allow one or more teeth to be moved by the upper appliance and/or the lower appliance, respectively. As a result, the upper appliance and/or the lower appliance may move one or more teeth to a corrected position and/or one or more teeth may remain in the corrected position with, for example, a reline material. The upper appliance and/or the lower appliance may have a narrowed area. The narrowed area may be secured to one or more teeth. As a result, one or more teeth may be rotated and/or may be moved by the upper appliance and/or the lower appliance. Further, the upper appliance and/or the lower appliance may have elevations or ribs in an interior of the upper appliance and/or the lower appliance, respectively. The elevations or ribs may contact, may rotate and/or may move one or more teeth of the patient.

The upper jaw and/or the lower jaw may require moving and/or correcting with respect to each other. The lower jaw may be movable with respect to the upper jaw. A front-to-rear position, a side-to-side or lateral position and/or a vertical position of the lower jaw may be corrected to align with a position of the upper jaw. A labial tab may be attached to the lower appliance and may extend upward with respect to the front portion or a labial portion of the lower appliance. The labial tab may contact a labial portion of the upper appliance and/or upper front teeth of the patient. A lingual tab may be attached to an upper appliance to contact the lingual surface of a lower appliance or the lower front teeth or lower jaw to position the lower jaw forward and to encourage the forward growth of the lower jaw. An alternative upper labial tab extending downward or a lower lingual tab extending upward may be used to retrude the lower jaw and inhibit its forward growth. The lingual tab and/or the labial tab may be shaped to accommodate the lower appliance and/or the upper appliance or the arch of the lower jaw and/or the upper jaw, respectively, in the mouth of the patient.

Alternatively, the upper appliance and the lower appliance may be linked together by, for example, wedges, guides, tabs, inclines, hinges of various designs and/or the like. A shell may snap over the upper appliance and/or the lower appliance to link the upper appliance and the lower appliance together. Alternatively, the shell may snap over the upper appliance and/or the lower appliance and/or may cover the natural dentition of the arch of the lower jaw and/or the upper jaw, respectively, of the patient. Rims, borders or overlays may be attached over occlusal surfaces in the mouth of the patient to limit movements, such as, for example, lateral movements, vertical movements or front-to-back movements of the upper jaw and/or the lower jaw.

To this end, in an embodiment of the present invention, a dental appliance worn on a dentition of a mouth of a user wherein the dentition has a first tooth and a second tooth is provided. The dental appliance has a generally U-shaped base sized to receive the dentition of the user wherein the generally U-shaped base has a first portion and a second portion wherein the first portion receives the first tooth. Further, the first portion of the generally U-shaped base is attached to the mouth of the user via the first tooth and a material located between the second portion of the generally U-shaped base and the first tooth wherein the second portion of the generally U-shaped base moves the second tooth of the user.

In an embodiment, the material is a reline material.

In an embodiment, the material is an adhesive or a glue.

In an embodiment, the material is heated prior to insertion between the generally U-shaped base and the first tooth.

In an embodiment, the material hardens to secure the generally U-shaped base to the mouth of the user.

In an embodiment, the first portion or the second portion of the generally U-shaped base is preformed or customized or both preformed and customized.

In an embodiment, the dental appliance has an opening formed in the generally U-shaped base for receiving the first tooth, the second tooth or more than two teeth of the dentition.

In an embodiment, the generally U-shaped base guides an erupting tooth of the user into the mouth of the user.

In an embodiment, the first portion of the generally U-shaped base is constructed from a first material and the second portion of the base is constructed from a second material wherein the first material is stiffer than the second material.

In an embodiment, the dental appliance has a reline material insertable between the second tooth and the second portion of the generally U-shaped base.

In an embodiment, the dentition is a deciduous or a permanent or both deciduous and permanent.

In another embodiment of the present invention, a dental appliance worn in a mouth of a user wherein the mouth of the user has a dentition having a first tooth and a second tooth is provided. The dental appliance has a generally U-shaped base having an interior surface and an exterior surface wherein the generally U-shaped base is sized to receive the dentition of the user wherein the interior surface of the generally U-shaped base has a first portion and a second portion wherein the interior surface contacts the dentition wherein the first portion of the generally U-shaped base receives the first tooth of the dentition wherein the generally U-shaped base is constructed from a first material and further wherein the first portion of the generally U-shaped base is attached to the dentition of the user via the first tooth. Moreover, the appliance has an elevation attached on the second portion of the interior of the generally U-shaped base wherein the elevation extends outward with respect to the interior of the generally U-shaped base wherein the elevation contacts the second tooth of the dentition and further wherein the elevation moves the second tooth.

In an embodiment, the elevation is integrally formed with the generally U-shaped base.

In an embodiment, the elevation is constructed from a second material wherein the second material is softer than the first material.

In an embodiment, the elevation extends into a labial area, a buccal area or a lingual area of the mouth of the user.

In an embodiment, the elevation applies a pressure to the second tooth to move the second tooth.

In an embodiment, the dental appliance has an opening formed in the generally U-shaped base for receiving the first tooth, the second tooth or more than two teeth of the dentition.

In an embodiment, the generally U-shaped base guides an erupting tooth of the user into the mouth of the user.

In an embodiment, the dental appliance has a reline material insertable between the second tooth and the generally U-shaped base.

In an embodiment, the first portion or the second portion of the generally U-shaped base is preformed, customized or both preformed and customized.

In an embodiment, the dentition is deciduous or permanent or both deciduous and permanent.

In another embodiment of the present invention, adental appliance worn on a dentition in a mouth of a user wherein the dentition has an orthodontic condition is provided. The dental appliance has a generally U-shaped base having a length defined between a first end and a second end wherein the generally U-shaped base is sized to receive the dentition of the mouth of the user wherein the generally U-shaped base has a first portion and a second portion wherein the first portion of the generally U-shaped base receives a first tooth of the dentition and further wherein the first portion of the generally U-shaped base is attached to the dentition via the first tooth is provided. Further, the dental appliance has a first wire imbedded in the generally U-shaped base wherein the first wire extends from the first end to a point along the length of the generally U-shaped base wherein the first wire moves a second tooth of the dentition wherein the first wire corrects the orthodontic condition of the dentition.

In an embodiment, a break in the first wire separates the first wire into a first portion and a second portion.

In an embodiment, the dental appliance has a screw attached to the first wire wherein the screw connects the first end of the generally U-shaped base to the second end of the generally U-shaped base.

In an embodiment, the dental appliance has a second wire attached to the first wire.

In an embodiment, the orthodontic condition is a rotation, a sliding movement, thumb sucking, tongue thrust swallowing, a tongue habit, an expansion of an arch or a distalized tooth.

In an embodiment, the second portion of the generally U-shaped base moves the second tooth of the dentition.

In an embodiment, the dental appliance has an opening formed in the generally U-shaped base for receiving the first tooth, the second tooth or more than two teeth of the dentition.

In an embodiment, the generally U-shaped base guides an erupting tooth of the user into the mouth of the user.

In an embodiment, the dental appliance has a reline material insertable between the second tooth and the generally U-shaped base.

In an embodiment, the first portion or the second portion of the generally U-shaped base is preformed, customized or both preformed and customized.

In an embodiment, the dentition is deciduous, permanent or both deciduous and permanent.

In an embodiment, the first portion of the generally U-shaped base is constructed from a first material and the second portion of the generally U-shaped base is constructed from a second material wherein the first material is stiffer than the second material.

In another embodiment of the present invention, a system for correcting an orthodontic condition of a mouth of a user wherein the mouth of the user has a first dentition attached to a first jaw of the user and a second dentition attached to an second jaw of the user is provided. The system has a first dental appliance sized to receive the first dentition of the first jaw wherein the first dental appliance has a first portion and a second portion wherein the first dental appliance receives a first tooth of the first dentition and further wherein the first portion of the first dental appliance is attached to the upper jaw via the first tooth of the first dentition. Further, the system has a second dental appliance sized to receive the second dentition of the second jaw wherein the second dental appliance has a first portion and a second portion wherein the second dental appliance receives a first tooth of the second dentition and further wherein the first portion of the second dental appliance is attached to the second jaw via the first tooth of the second dentition. Moreover, the system has a fastening means attaching the first dental appliance and the second appliance wherein the first dental appliance and the second dental appliance is worn by the user and further wherein the second portion of the first dental appliance or the second portion of the second dental appliance corrects the orthodontic condition of the mouth of the user.

In an embodiment, the fastening means is a hinge, a wedge, a rim, a border, a guide, an incline, an overlay or a shell.

In an embodiment, the system has an opening formed in the first dental appliance or the second dental appliance.

In an embodiment, the base guides an erupting tooth of the user into the mouth of the user.

In an embodiment, the first portion or the second portion of the first dental appliance or the second dental appliance is preformed or customized or both preformed and customized.

In an embodiment, the first dentition or the second dentition is deciduous or permanent or both deciduous and permanent.

In another embodiment of the present invention, a dental appliance worn in the mouth of a user wherein the mouth of the user has a first jaw having a dentition and a second jaw opposite to the first jaw wherein the dentition has a first tooth and a second tooth wherein the second jaw is in a first position with respect to the first jaw wherein the mouth of the user has an orthodontic condition based on the first position of the second jaw is provided. The dental appliance has a generally U-shaped base sized to receive the first dentition of the first jaw wherein the generally U-shaped base has an exterior surface for contacting the mouth of the user wherein the generally U-shaped base has a first portion and a second portion wherein the first portion receives the first tooth of the first dentition wherein the first portion of the generally U-shaped base is attached to the first jaw via the first tooth of the first dentition. Further, the dental appliance has a tab attached to the exterior surface of the generally U-shaped base wherein the tab extends outward with respect to the exterior surface of the generally U-shaped base wherein the tab moves the second jaw to a second position with respect to the first jaw wherein the tab corrects the orthodontic condition.

In an embodiment, the tab maintains the second jaw in the second position with respect to the first jaw.

In an embodiment, the tab is attached to the generally U-shaped base via a snap or an adhesive.

In an embodiment, the tab is integrally formed in the generally U-shaped base.

In an embodiment, the second position of the second jaw is positioned in a rearward direction or in a forward direction with respect to the first position of the second jaw of the mouth of the user.

In an embodiment, the dental appliance has an opening formed in the generally U-shaped base for receiving the dentition of the first jaw.

In an embodiment, the base guides an erupting tooth into the mouth of the user.

In an embodiment, the first portion or the second portion of the generally U-shaped base is preformed or customized or both preformed and customized.

In an embodiment, the first dentition is deciduous or permanent or both deciduous and permanent.

In an embodiment, the second portion of the generally U-shaped base moves the second tooth of the dentition.

In an embodiment, the dental appliance has a reline material insertable between the second tooth and the base.

In an embodiment, the first portion of the generally U-shaped base is constructed from a first material and the second portion of the generally U-shaped base is constructed from a second material wherein the first material is stiffer than the second material.

It is, therefore, an advantage of the present invention is to provide an upper appliance and/or a lower appliance and a method for attaching the appliance to a first area of a dentition and moving teeth at a second area of the dentition which may be in part customized to adhere to the teeth in a first area and to place pressure onto teeth in a second area.

Another advantage of the present invention is to provide an upper appliance and/or a lower appliance and a method for attaching the appliance to a first area of a dentition and moving teeth at a second area of the dentition which has protrusions on an interior of sockets and/or slots for one or more teeth to rotate the teeth more effectively.

And, another advantage of the present invention is to provide an upper appliance and/or a lower appliance and a method for attaching the appliance to a first area of a dentition and moving teeth at a second area of the dentition which has prefabricated sockets for one or more teeth and/or customized sockets for one or more teeth to slide one or more teeth mesio-distally and/or mesio-lingually and/or bucco-lingually for intercuspation of the teeth.

Yet another advantage of the present invention is to provide an upper appliance and/or a lower appliance and a method for attaching the appliance to a first area of a dentition and moving teeth at a second area of the dentition which has prefabricated sockets for one or more teeth and/or customized sockets for one or more teeth to slide one or more teeth mesio-distally and/or labio-lingually and/or bucco-lingually for spacing of the teeth and/or closing of spaces between the teeth.

A further advantage of the present invention is to provide an upper appliance and/or a lower appliance and a method for attaching the appliance to a first area of a dentition and moving teeth at a second area of the dentition which have prefabricated sockets for one or more teeth and/or slots for one or more teeth to allow one or more teeth to be guided in a mouth during eruption.

Moreover, an advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth for one or more of the teeth to allow a mouth to freely open and close more comfortably.

And, another advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth for one or more teeth to allow an arch of an upper jaw and an arch of lower jaw to be linked together and/or to align the upper jaw and the lower jaw without interfering with natural jaw movement.

Yet another advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth to move the one or more teeth of the patient.

Another advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth for one or more teeth with wires thereon to expand and/or constrict the upper appliance and/or the lower appliance.

Yet another advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth to fix one or more teeth with a reline material for maintaining a position of the appliance without displacement of the appliance.

A still further advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth to place a tab on the upper appliance and/or the lower appliance to control position of a lower jaw with respect to the upper jaw.

Moreover, an advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth to allow a patient to wear the appliance while talking and/or not talking.

And, another advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth to allow a patient to straighten one or more teeth without exercise and/or pressure applied by clenching the jaws.

Yet another advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth with a reline material to move one or more teeth in an area without reline material while sleeping.

Another advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth to allow the appliance to be used as a retainer after one or more teeth are moved.

Yet another advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth to prevent thumb sucking by the patient.

A still further advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth to correct swallowing and/or tongue problems.

Moreover, an advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth to fix positions of a first jaw with respect to a second jaw for lower jaw advancement and growth.

And, another advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth to depress and/or to erupt one or more teeth of the dentition.

Yet another advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth to allow one or more teeth to be distalized and/or to be mesialized in the upper arch and/or in the lower arch.

Another advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth to open and/or close spaces and rotate one or more teeth.

Yet another advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth and a reline material thereon to increase an ability of the appliance to be retained onto one or more teeth.

A still further advantage of the present invention is o provide an upper appliance and/or a lower appliance and a method for attaching the appliance to a first area of a dentition and moving teeth at a second area of the dentition which have customized sockets for one or more teeth and/or prefabricated sockets for one or more teeth to be used as a retainer to maintain one or more teeth in a position after the teeth have been moved.

Moreover, an advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth and a material which can be heated and/or squeezed into undercuts of the dentition for increasing adhesion to a mouth of a patient.

And, another advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth and to be made in part or in whole of one or more materials of varying softness and/or hardness to increase tooth movement and/or retainability.

Yet another advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth and/or slots for one or more teeth to be used during primary, mixed and/or permanent dentitions.

Another advantage of the present invention is to provide an upper appliance and/or a lower appliance and a method for attaching the appliance to a first area of a dentition and moving teeth at a second area of the dentition which have customized for one or more teeth and/or prefabricated sockets for one or more teeth which may be worn after a pacifier.

Yet another advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth to be used after or in combination with another orthodontic treatment technique.

A still further advantage of the present invention is to provide an upper appliance and/or a lower appliance and a method for attaching the appliance to a first area of a dentition and moving teeth at a second area of the dentition which have customized sockets for one or more teeth and/or prefabricated sockets for one or more teeth to be used in combination with a shell which may snap over the appliance to correct a lower jaw advancement and/or lateral movements and/or vertical movements.

Additional features and advantages of the present invention are described in, and will be apparent from, the detailed description of the presently preferred embodiments and from the drawings.

### BRIEF DESCRIPTION OF THE DRAWINGS

FIG. 1 illustrates a perspective view of an upper customized appliance in an embodiment of the present invention.

FIG. 2 illustrates a perspective view of a lower customized appliance in an embodiment of the present invention.

FIG. 3 illustrates a perspective view of an upper prefabricated appliance in an embodiment of the present invention.

FIG. 4 illustrates a perspective view of a lower prefabricated appliance in an embodiment of the present invention.

FIG. 5 illustrates a side view of an upper prefabricated appliance in an embodiment of the present invention.

FIG. 6 illustrates a side view of a lower prefabricated appliance in an embodiment of the present invention.

FIG. 7 illustrates a front plan view of an upper prefabricated appliance in an embodiment of the present invention.

FIG. 8 illustrates a front plan view of a lower prefabricated appliance in an embodiment of the present invention.

FIG. 9 illustrates a perspective view of an insertable wire in an embodiment of the present invention.

FIG. 10 illustrates a perspective view of an insertable wire with a rapid expansion screw thereon in an embodiment of the present invention.

FIG. 11 illustrates a perspective view of an insertable wire with a rapid expansion screw thereon in an embodiment of the present invention.

FIG. 12 illustrates a perspective view of an insertable wire with a rapid expansion screw thereon having a split in the wire at a midline in an embodiment of the present invention.

FIG. 13 illustrates a perspective view of an insertable wire with a rapid expansion screw thereon and an expandable tube at the midline of the wire in an embodiment of the present invention.

FIG. 14a illustrates a perspective view of an insertable wire with a rapid expansion screw thereon and an expandable tube at a front of the wire in a split appliance in an embodiment of the present invention.

FIG. 14b illustrates a perspective view of an insertable wire with a rapid expansion screw thereon and vertical shields to stabilized the wire and attachment to an appliance in an embodiment of the present invention.

FIG. 15 illustrates a perspective view of an appliance with a lingual wire and a bucco-labial wire imbedded into a lingual surface and a bucco-labial surface in an embodiment of the present invention.

FIG. 16 illustrates a perspective view of a wire with prongs attached thereon to correct swallowing, tongue thrust patterns and thumb sucking in an embodiment of the present invention.

FIG. 17 illustrates a perspective view of a wire with a rake-type attachment thereon to correct swallowing, tongue-thrust patterns and thumb sucking in an embodiment of the present invention.

FIG. 18 illustrates a perspective view of a wire with a roller-type attachment thereon to correct swallowing, tongue-thrust patterns and thumb sucking in an embodiment of the present invention.

FIG. 19 illustrates a perspective view of a lower wire with prongs thereon to prevent forward positioning of the tongue in an embodiment of the present invention.

FIG. 20 illustrates a perspective view of a lower wire with vertical posterior shields to prevent a lateral tongue thrust.

FIG. 21 illustrates a perspective view of an upper wire or a lower wire with an attachment thereon as a lingual tab into a lower arch to hold a lower jaw forward in an embodiment of the present invention.

FIG. 22 is a side view of the upper wire or the lower wire of FIG. 21 in an embodiment of the present invention.

FIG. 23 is a perspective view of a lower labio-buccal wire with a labial attachment thereon as a labial tab to keep a lower jaw in a forward position in an embodiment of the present invention.

FIG. 24 is a side view of the lower labio-buccal wire of FIG. 23 in an embodiment of the present invention.

FIG. 25 is a perspective view of an upper bucco-labial wire with a wire attachment thereon to keep a lower jaw in a forward position to inhibit forward growth of the lower jaw in an embodiment of the present invention.

FIG. 26 is a side view of the upper bucco-labial wire of FIG. 25 in an embodiment of the present invention.

FIG. 27 is a perspective view of an upper wire or a lower wire with expansion screw thereon with splits in a base wire in an embodiment of the present invention.

FIG. 28 is a perspective view of a wire with a tube with a spring for opening a space in a dental arch in an embodiment of the present invention.

FIG. 29 is a perspective view of an insertable wire with a labial bumper shield attachment thereon in an embodiment of the present invention.

FIG. 30 is a perspective view of a labio-buccal wire with wire attachments thereon to distalize teeth in an embodiment of the present invention.

FIG. 31 is a perspective view of a lingual wire with wire attachments thereon to distalize certain teeth in an embodiment of the present invention.

FIG. 32 is a top plain view of an appliance with a lingual wire inserted into the appliance with wire attachments to distalize molars in an embodiment of the present invention.

FIG. 33 is a perspective view of an upper appliance with a molded lingual tab to maintain a lower jaw advancement in an embodiment of the present invention.

FIG. 34 is a side view of an upper appliance and a lower appliance with a lingual tab attached thereon to the upper appliance to maintain a lower jaw in a forward position in an embodiment of the present invention.

FIG. 35 is a perspective view of an appliance with an attachable lingual tab thereon in an embodiment of the present invention.

FIG. 36 is a front plan view of a glueable lingual tab in an embodiment of the present invention.

FIG. 37 is a side view of a glueable lingual tab in an embodiment of the present invention.

FIG. 38 is a side view of an upper appliance in an embodiment of the present invention.

FIG. 39 is a perspective view of a lingual tab to snap onto a labial surface of an appliance in an embodiment of the present invention.

FIG. 40 is a side view of a lingual tab to snap onto a labial surface of an appliance in an embodiment of the present invention.

FIG. 41 is a cross-sectional view of an upper appliance in another embodiment of the present invention.

FIG. 42 is a perspective view of an upper appliance with a lingual tab to snap onto a labial surface of an upper appliance in an embodiment of the present invention.

FIG. 43 is a side view of a lower appliance with a labial tab to maintain a lower jaw in a forward position relative to an upper jaw in an embodiment of the present invention.

FIG. 44 is a cross-sectional view of an anterior section of an upper appliance and a lower appliance in a position on teeth with a labial tab on the lower appliance to maintain a lower jaw in a forward position in an embodiment of the present invention.

FIG. 45 is a cross-section view of an upper appliance and a lower appliance in a position on teeth to increase overbite and overjet by overclosure in an embodiment of the present invention.

FIG. 46 is a side view of an upper appliance and a lower appliance in a position on teeth with extended shelves to prevent overclosure in an embodiment of the present invention.

FIG. 47 is a cross-sectional view of an upper appliance and a lower appliance in a position on teeth with gingival, incisal labial and lingual ribs for rotating the teeth in an embodiment of the present invention.

FIG. 48 is a cross-sectional view of a lower appliance with ribs and a narrow socket in an embodiment of the present invention.

FIG. 49 is a cross-sectional view of an upper appliance with ribs and a narrow socket in an embodiment of the present invention.

FIG. 50 is a perspective view of a lingual upper wire and/or a lingual lower wire with finger springs to distalize and/or to rotate teeth in an embodiment of the present invention.

FIG. 51 is a perspective view of a lingual upper wire or a lingual lower wire with a finger spring to rotate and/or to move a tooth laterally and/or labio-lingually in an embodiment of the present invention.

FIG. 52 is a perspective view of a lower appliance and an upper appliance having a lingual upper wire and a lingual lower wire connected by a hinge in an embodiment of the present invention.

FIG. 53 is a side view of an upper appliance and a lower appliance in an embodiment of the present invention.

FIG. 54 is a side view of a shell over an upper appliance and a lower appliance in an embodiment of the present invention.

FIG. 55 is a cross-sectional view of an upper appliance in a position on a tooth in an embodiment of the present invention.

FIG. 56 is a cross-sectional view of a lower appliance in a position on a tooth in an embodiment of the present invention.

### DETAILED DESCRIPTION OF THE PRESENTLY PREFERRED EMBODIMENTS

The present invention generally relates to an orthodontic appliance which may attach to a dentition of a patient and/or may move one or more teeth of the patient. More specifically, the present invention relates to an upper orthodontic appliance and/or a lower orthodontic appliance that may attach to a first area of the dentition and/or may move the teeth at a second area of the dentition. The upper appliance and/or the lower appliance may have a first area to secure to one or more teeth of the dentition of the patient and/or a second area to move one or more teeth of the patient. The upper appliance and/or the lower appliance may be preformed, may be customized for the patient or may be both preformed and customized for the patient. The first area and/or second area of the upper appliance and/or the lower appliance may have, for example, a single slot for one or more teeth or one or more sockets for one or more teeth and/or one or more slots for one or more teeth to receive one or more teeth of the patient.

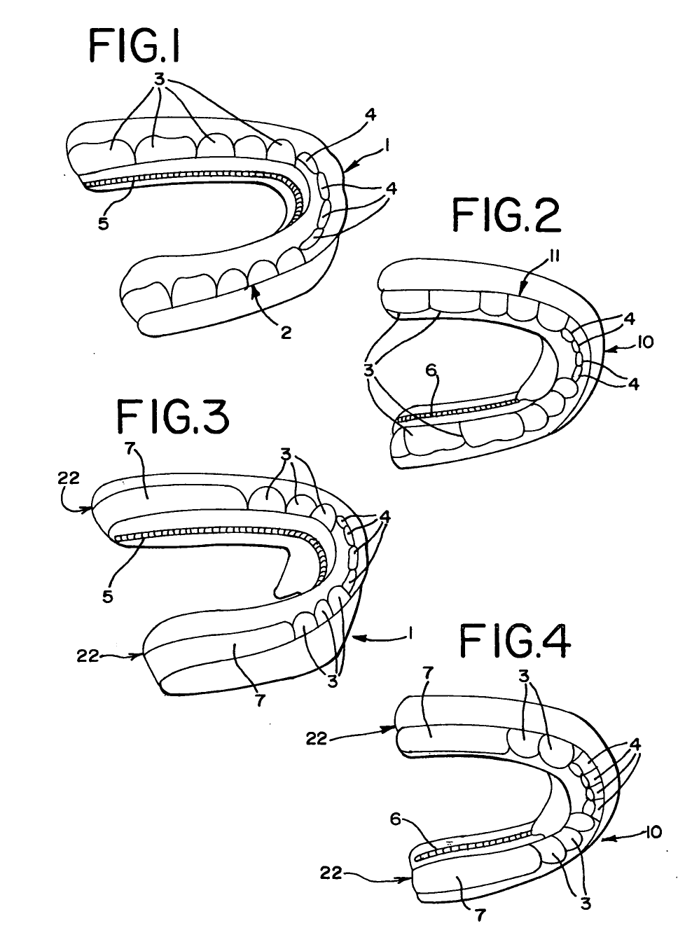

Referring now to the drawings wherein like numerals refer to like parts, FIGS. 1 and 2 illustrate an upper appliance 1 and a lower appliance 10, respectively. The upper appliance 1 and/or the lower appliance 10 may receive teeth and/or a dentition (not shown in the drawings) of a patient. The dentition of the patient may include upper teeth and/or lower teeth. The patient may have an upper jaw (not shown in the drawings) and/or a lower jaw (not shown in the drawings). The upper jaw may have an arch (not shown in the drawings) which may have the upper teeth (not shown in the drawings) thereon. The upper teeth of the patient may erupt and/or may extend outward or downward with respect to the arch of the upper jaw. The lower jaw may have an arch (not shown in the drawings) which may have the lower teeth (not shown in the drawings) thereon. The lower teeth of the patient may erupt and/or may extend outward or upward with respect to the arch of the lower jaw.

The upper appliance 1 may have a lower surface 2 which may abut tops (not shown in the drawings) of the upper teeth of the patient. The lower appliance 10 may have a lower surface 11 which may abut tops (not shown in the drawings) of the lower teeth of the patient. The lower surfaces 2, 11 may be, for example, flat and/or indented to accommodate occlusal surfaces (not shown in the drawings) of the upper teeth and the lower teeth, respectively. The upper appliance 1 and/or the lower appliance 2 may be constructed from, for example, rubber, plastic, polyurethane, polyethylene, polypropylene, polyvinyl-chloride, a stiff polymer material, a soft polymer material, a combination of both a stiff polymer material and a soft polymer material or other material known by those skilled in the art.

The upper appliance 1 and/or the lower appliance 10 may have rear sockets 3 and/or front sockets 4. The rear sockets 3 and/or the front sockets 4 may be customized for the patient to receive one or more teeth of the patient or may be preformed based on sizes of teeth of the patient or from standards and/or means of sizes of teeth in general. The rear sockets 3 and/or the front sockets 4 may be customized based on an impression of a mouth of the patient. The rear sockets 3 and/or the front sockets 4 may be a duplication of the dentition and/or tooth arrangement of the patient. The rear sockets 3 and/or the front sockets 4 of the upper appliance 1 may receive the upper teeth of the patient. The rear sockets 3 and/or the front sockets 4 of the lower appliance 10 may receive the lower teeth of the patient.

The upper teeth and/or the lower teeth of the patient may be reset into corrected positions which are an improvement from an existing arrangement of the teeth of the patient. The corrected positions of the teeth may be determined by a computer (not shown in the drawings). The upper teeth and/or the lower teeth of the patient may be moved into the corrected positions via the upper appliance 1 and the lower appliance 10, respectively. Movement of the upper teeth and/or the lower teeth of the patient may be gradual by more than one upper appliance 1 and/or more than one lower appliance 10, respectively. The movement of the upper teeth and/or the lower teeth may depend on a stiffness and/or a softness of the upper appliance 1 and/or the lower appliance 10, respectively, and/or a severity of malpositions of the teeth of the patient.

The upper appliance 1 and/or the lower appliance 10 may be constructed from a stiff material. The rear sockets 3 and/or the front sockets 4 which may rearrange the teeth of the patient may be made of a soft material which may be resilient. The upper teeth and/or the lower teeth of the patient may not require straightening by the upper appliance 1 and/or the lower appliance 10, respectively, at the rear sockets 3. The upper teeth and/or lower teeth of the patient may require moving by the upper appliance 1 and/or the lower appliance 10, respectively, at the front sockets 4. The rear sockets 3 of the upper appliance 1 and/or the lower appliance 10 may adhere to the rear teeth of the patient which do not require moving, straightening and/or rearrangement. The rear sockets 3 of the upper appliance 1 and/or the lower appliance 10 may be made from the stiff material. The front sockets 4 of the upper appliance 1 and/or the lower 10 may receive the front teeth which may require moving, straightening and/or rearrangement. The front sockets 4 of the upper appliance 1 and/or the lower appliance 10 may be made from the softer material. Alternatively, the front teeth may not require movement and/or may have a stiffer material in the upper appliance 1 and/or the lower appliance 10 while the rear teeth may require movement and the upper appliance 1 and/or the lower appliance 10 may be made of a softer material in the rear area. Furthermore, the upper appliance 1 and/or the lower appliance 10 may be made of the softer material and/or the stiffer material.

FIGS. 3 and 4 illustrate the upper appliance 1 and the lower appliance 10, respectively. The upper appliance 1 and/or the lower appliance 10 may have a posterior slot 7, the rear sockets 3 and/or the front sockets 4. The posterior slot 7 may receive one or more teeth of the patient and/or may be preformed. The posterior slot 7 may be customized for the patient to receive one or more teeth of the patient. Alternatively, the posterior slot 7 may be preformed to receive one or more teeth of the patient. In yet another alternative, the posterior slot 7, the rear sockets 3 and/or the front sockets 4 may be preformed and/or may be sized to receive the upper teeth and/or the lower teeth of the patient. Moreover, one of the rear sockets 3 and/or one of the front sockets 4 may be preformed and/or may be sized to receive one or more of the upper teeth and/or one or more of the lower teeth of the patent.

The posterior slot 7 of the upper appliance 1 may receive upper posterior teeth (not shown in the drawings) of the patient. The slot 7 of the lower appliance 10 may receive lower posterior teeth (not shown in the drawings) of the patient. The upper posterior teeth and/or the lower posterior teeth may be, for example, upper molars and/or lower molars, respectively, of the patient. The upper appliance 1 and/or the lower appliance 10 may consist of one or more teeth requiring adherence to the dentition which may be attached with the a reline material or other attachment material.

The upper posterior teeth and/or the lower posterior teeth of the patient may not require moving, straightening and/or correcting by the upper appliance 1 and/or the lower appliance 10, respectively, at the posterior slot 7. The posterior slot 7 of the upper appliance 1 and/or the lower appliance 10 may adhere to the upper posterior teeth and/or the lower posterior teeth, respectively, of the patient which do not require straightening and/or rearrangement. The posterior slot 7 may be constructed from the stiff material to attach the upper appliance 1 and/or the lower appliance 10 to the upper posterior teeth and/or the lower posterior teeth, respectively, of the patient.

The upper appliance 1 and the lower appliance 10 as shown in FIGS. 1 and 2, respectively, may have grooves 5, 6, respectively. The groove 5 and/or the groove 6 may accommodate a lingual wire 20 as illustrated in FIG. 9. The lingual wire 20 may be inserted and/or may be placed into the groove 5 and/or the groove 6 of the upper appliance 1 and/or the lower appliance 10, respectively. Further, the lingual wire 20 may be secured by, for example, a glue, a bond, a self-cure acrylic and/or the like. The lingual wire 20 may be expanded and/or may be constricted to widen or narrow, respectively, the upper appliance 1 and/or the lower appliance 10 by bending the lingual wire 20. The lingual wire 20 may force the upper appliance 1 and/or the lower appliance 10 against the dentition and/or the teeth of the patient. As a result, the upper appliance 1 and/or the lower appliance 10 may expand and/or may constrict the arch of the upper jaw and/or the arch of the lower jaw, respectively, of the patient. Alternatively, the lingual wire 20 may be attached to a buccal surface (not shown in the drawings) and/or a labial surface (not shown in the drawings) of the upper appliance 1 and/or the lower appliance 10. The buccal surface of the upper appliance 1 and/or the lower appliance 10 may be adjacent to and/or may contact a cheek of the mouth of the patient. The labial surface of the upper appliance 1 and/or the lower appliance 10 may be adjacent to and/or may contact a lip of the mouth of the patient.

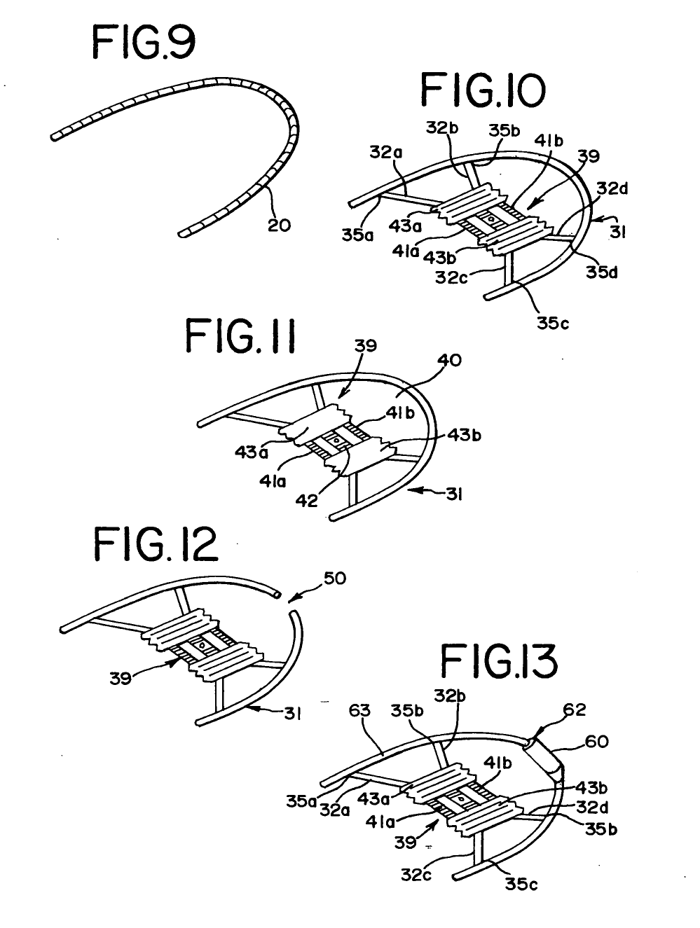

The lingual wire 20 may correct the orthodontic conditions of the teeth and/or the dentition of the patient. For example, FIG. 10 illustrates a lingual wire 31 which may be inserted into the groove 5 of the upper appliance 1. The lingual wire 31 may be affixed to the upper appliance 1 with, for example, a self-cure acrylic and/or the like. The lingual wire 31 may be cut at a midline 40 as shown in FIG. 11 and/or at a separation 50 in FIG. 12. The screw attachment 39 may be attached to the lingual wire 31 via struts 32 at points 35a, 35b, 35c, 35d on the lingual wire 31. The screw attachment 39 may be opened and/or may be closed by turning a screw 42 clockwise and/or counter-clockwise, respectively. The screw 42 may be, for example, an expansion screw. As a result, the screw 42 may separate pins 41a, 41b and/or may separate a housing 43a, 43b of the screw attachment 39. The lingual wire 31 may be separated at the midline 40 to a distance 50 as illustrated in FIG. 12.

FIG. 14a illustrates an appliance 70 which may be the upper appliance 1 or the lower appliance 10. The appliance 70 may be separated at a midline 71 into a first upper half 72 and a second upper half 73 as shown in FIG. 14a. The midline 71 may be located in a front section 20 of the appliance 70 as shown in FIG. 14a. Alternatively, the midline 71 may be located in an off-center section 21 of the appliance 70 which may be located between the front section 20 of the appliance 70 and a rear section 22 as shown at a first expansion split 71a and a second expansion split 71b in FIG. 27. The screw attachment 39 may be soldered and/or may be welded at points 35a, 35b, 35c, 35d to the lingual wire 31 to secure the screw attachment 39 to the lingual wire 31 by beams 32. Welding and/or soldering the screw attachment 39 to the lingual wire 31 may stabilize and/or may prevent the upper halves 72, 73 from twisting with respect to each other. The appliance 70 may be constructed from, for example, rubber or plastic or other material known to those skilled in the art.

Alternatively, a lingual wire 63 may have the screw attachment 39 and a sleeve 60 thereon as illustrated in FIG. 13. The sleeve 60 may be, for example, an opened tubular cover. The screw attachment 39 may be attached to the lingual wire 63 via the beams 32a, 32b, 32c, 32d. The lingual wire 63 may be inserted into the sleeve 60 at an opening 62. The screw 42 may be opened to separate pins 41a, 41b and/or to separate a housing 43a, 43b. As a result, the lingual wire 63 may slide partially out of the sleeve 60 to extend and/or to widen the lingual wire 63 without detachment of the two halves of the wire at the separation 50 in FIG. 12.

As illustrated by FIG. 14a, the sleeve 60 and/or the lingual wire 63 may extend across the midline 71 from the first upper half 72 to the second upper half 73. Further, the sleeve 60 and/or the lingual wire 63 may connect the first half 72 to the second half 73. The sleeve 60 and/or the lingual wire 63 may stabilize the upper halves 72, 73 from twisting with respect to each other. The upper halves 72, 73 of the upper appliance 1 may fit the dentition of the patient and/or may receive the upper teeth of the patient. The upper appliance 1 and/or the lower appliance 10 may be based on models of the teeth and/or the dentition of the patient and/or may be preformed from standards or from teeth of the patient. The rear sockets 3, the front sockets 4, the upper appliance 1 and/or the lower appliance 10 may be made by, for example, vacuum-forming, stereolithography from digital images of the dentition of the patient and/or by injection molding and/or the like.

As illustrated in FIGS. 1 and 2, the upper appliance 1 and/or the lower appliance 10 may have the rear sockets 3 and/or the front sockets 4 which may be custom molded for the patient and/or prefabricated to receive the upper teeth of the patient. Further, the upper appliance 1 and/or the lower appliance 10 may have custom molded and/or prefabricated front sockets 3 for the patient and/or custom molded and/or prefabricated rear sockets 4 for the patient and the posterior slot 7 and/or an interior slot (not shown). The posterior slot 7 may be customized to the patients teeth and/or prefabricated to receive the posterior teeth of the patient as illustrated in FIGS. 3 and 4. The midline 71 may be in the front section 20a of the appliance 70 as shown in FIG. 14a and/or at any other location in appliance 70. The appliance 70 may be prefabricated in the front section 20a and/or the rear section 22 to receive one or more teeth and/or may be custom molded for the patient and/or prefabricated in the rear section 22 to receive one or more teeth of the patient. As a result, the rear section 22 and/or the front section 20 may attach and/or may hold the appliance 70 to the teeth of the patient.

The front sockets 3, the rear sockets 4 and/or the posterior slot 7 and/or anterior slot for one or more teeth (not shown) may be prefabricated to receive one or more teeth of the patient based on standards or means of teeth. Further, a reline material (not shown in the drawings) may be inserted into the rear sockets 3, the front sockets 4 and/or the posterior slot 7 to attach the appliance 70 to one or more teeth of the patient. For example, maloccluded teeth of the patient may be inserted into the front section 20 of the appliance 70, and the reline material may be inserted into the rear section 22 of the appliance 70 to attach the appliance 70 to the teeth of the patient. As a result, a prefabricated appliance may be made to adhere to a rear area of the dentition of the patient that may not require straightening or moving or may not require tooth movement, such as, for example, the rear section 22 of the upper appliance 1 in FIG. 3 or the rear section 22 of the lower appliance 10 in FIG. 4.

The reline material may be a material which adheres to the dentition of the patient, such as, for example, a self-cure acrylic, a glue, a bond, an adhesive, a paste and/or the like. The reline material may require the appliance 70, the upper appliance 1, the lower appliance 10 and/or the dentition of the patient to be coated with a primer (not shown in the drawings). Further, the reline material may be secured to the appliance 70, the upper appliance 1 and/or the lower appliance by, for example, a mesh, a roughened surface and/or a bonding agent. For example, a self-cure acrylic material may require the surface of the appliance 70 to be coated with the primer. The self-cure acrylic material may be applied to the surface of the appliance 70. The teeth of the patient may be inserted into the appliance 70. The appliance 70 may receive the dentition and/or the teeth of the patient. As a result, the self-cure acrylic material may flow into interproximal undercuts of the teeth of the patient and may harden therein. The interproximal undercuts may be areas in the mouth of the patient which may be located between the teeth of the patient. The appliance 70 may be removed therefrom, and any excess of the self-cure acrylic may be removed from the appliance 70 and/or the teeth of the patient.

The appliance 70 may receive the teeth and/or the dentition of the patient and/or may not be easily dislodged from the teeth and/or the dentition of the patient. As a result, pressure may be constantly and/or passively applied to the teeth which may require moving, correcting and/or straightening by the appliance 70. As illustrated in FIG. 14a, the midline 71 of the appliance 70 may be split and may expand the appliance 70 at the midline 71, the front section 20a, the midline 71 or the off-center section 21. As a result, the first half 72 and/or the second half 73 may apply pressure to the teeth, the dentition and/or a tooth of the patient. The lingual wire 20, the lingual wire 31 or the lingual wire 63 may prevent the first half 72 and the second half 73 from twisting with respect to each other. Alternatively, first vertical plate 75a and/or second vertical plate 75b may be attached to the rear section at a first end 44 and/or a second end 45, respectively, of the lingual wire 31 as shown in FIG. 14b. The first end 44 may be opposite to the second end 45 of the lingual wire 31. As a result, the first vertical plate 75a and the second vertical plate 75b may stabilize the first half 72 and the second half 73, respectively, from twisting with respect to each other. The first vertical plate 75a and/or the second vertical plate 75b may be attached to the lingual wire 20, the lingual wire 31 and/or the lingual wire 63 via welding and/or soldering.

The screw attachment 39 may open the appliance 70 at a midline 71 which may correspond to a widened upper jaw and/or a space or spaces between the upper teeth and/or the lower teeth of the patient. The screw 42 may be closed and the distance 50 and/or the midline 71 may be closed. As a result, the space and/or the spaces between the upper teeth and/or the lower teeth of the patient may be closed. Alternatively, the first expansion split 71a, the second expansion split 71b and/or the screw attachment 39a, 39b, respectively, may be positioned at the teeth of the patient which may require separating and/or spacing as shown in FIG. 27. The screw attachment 39 may be opened, and the midline 71 may separate the first half 72 from the second half 73. As a result, the upper teeth and/or the lower teeth of the patient may be separated and/or spaced. Alternatively, the screw attachment 39 may be closed to move together the first half 72 and the second half 73 to close spaces between the teeth.

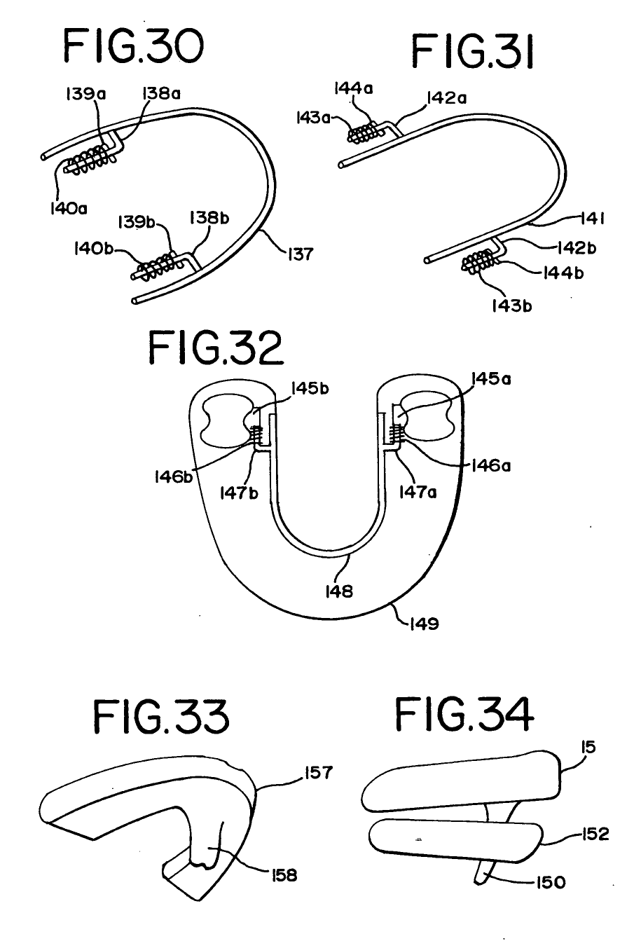

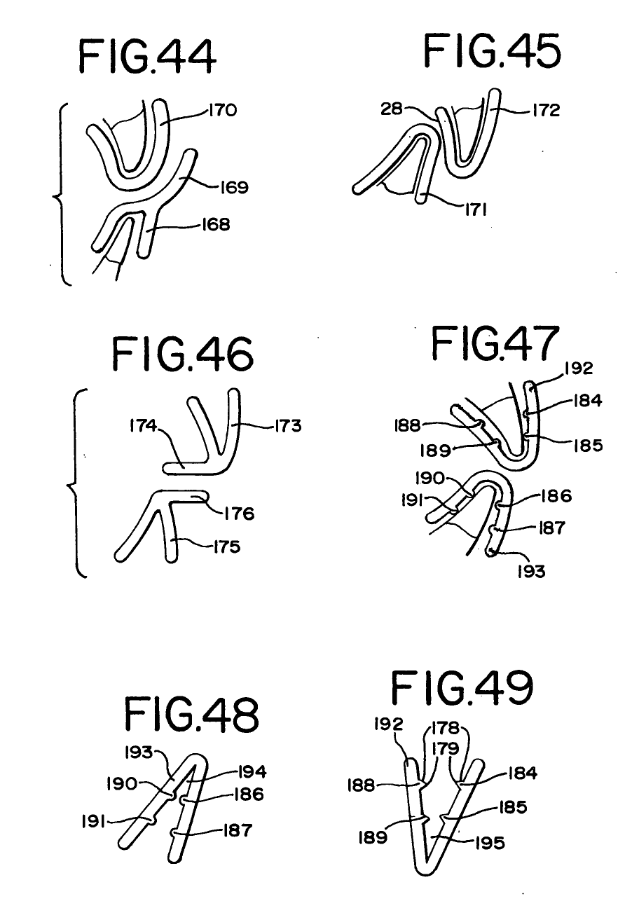

The upper appliance 1 and/or the appliance 70 may be a full upper dentition or a partial upper dentition which may only cover a portion of the upper dentition of the patient. The lower appliance 10 and/or the appliance 70 may be a full lower dentition or a partial lower dentition which may only cover a portion of the lower dentition of the patient. The upper appliance 1, the lower appliance 10, the appliance 70 and/or a hinged appliance 210 shown in FIG. 52 may be, for example, custom molded for the patient to receive one or more teeth of the patient or may be preformed to receive one or more teeth of the patient. Alternatively, the upper appliance 1, the lower appliance 10 and/or the appliance 70 and/or the appliance 210 may be both preformed and custom molded for the patient to receive one or more teeth of the patient. The upper appliance 1, the lower appliance 10 and/or the appliance 70 may link the arch of the upper jaw and the lower jaw together in a fixed position as shown in FIGS. 52-54 or a semi-fixed position as shown in FIGS. 34 and 44. Moreover, the upper appliance 1 and the lower appliance 10 may be attached and/or may be linked to each other with, for example, a hinge, molded together, wedges, guides, tabs, inclines, overlay cover or shell and/or the like.

As illustrated in FIG. 54, a shell 225 may be placed over the upper appliance 1 and/or the lower appliance 10 to link the upper appliance 1 to the lower appliance 10. Alternatively, the shell may be placed over the upper appliance 1 and/or the lower appliance 10 and may cover the dentition of the arch of the lower jaw and/or the arch of the upper jaw, respectively, of the patient. Attachments (not shown in the drawings), such as, for example, rims 230, 231, 232, 233, and FIGS. 55 and 56, borders, extensions 174, 176 as shown in FIG. 46 or overlays 225 as shown in FIG. 54 may be connected to the appliances 1, 10, 70, 210 to limit movements, such as, for example, lateral movements, vertical movements or front-to-back movements of the upper or the lower jaw.

FIG. 15 illustrates the upper appliance 1 or the lower appliance 10 which may have a wire 91 attached therein. The wire 91 may extend around the upper appliance 1 or the lower appliance 10 on a lingual surface via the grooves 5, 6 around the front section 105. The lingual surface may be adjacent to and/or may contact a tongue of the patient. The wire 91 may be placed into the groove 5 or the groove 6, respectively. The wire 91 may be secured to the upper appliance 1 or the lower appliance 10 via the glue, the bond, the self-cure acrylic and/or the like. Alternatively, a bucco-labial wire 192 may be secured to appliance 1, 10, 70, 210 on the buccal and labial surface and secured in a similar way.

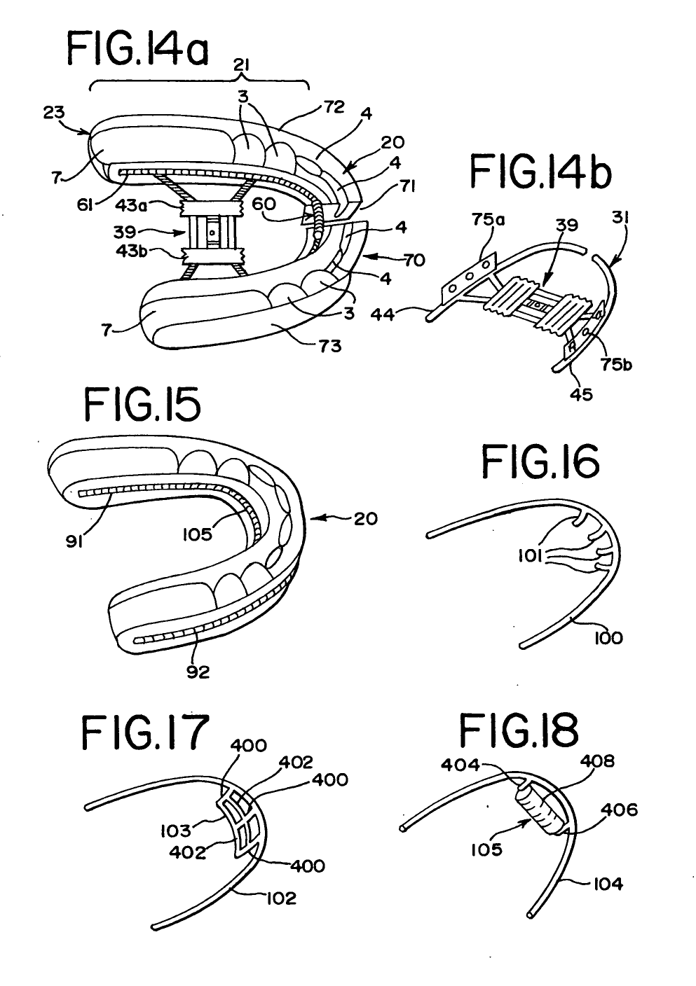

FIG. 16 illustrates a base wire 100 which may prevent and/or may stop thumb sucking. The wire base 100 may have one or more wire prongs 101 extending therefrom. The wire prongs 101 may be attached to the base wire 100 via welding or soldering. Alternatively, a rake 103 may be attached to the base wire 102 to prevent thumb sucking as illustrated in FIG. 17. The rake 103 may have support beams 400 which may extend outward with respect to the base wire 102. Further, the rake 103 may have wires 402 extending between each of the support beams 400. The rake 103 may be attached to the base wire 102 via welding or soldering. Another alternative may be a roller 105 attached to the base wire 104 to prevent thumb sucking as illustrated in FIG. 18. The roller 105 may have a first support wire 404 and a second support wire 406 extending outward with respect to the base wire 104. The roller 105 may have a cylinder 408 positioned between the first support wire 404 and the second support wire 406. The roller 105 may be attached to the base wire 104 via welding or soldering.

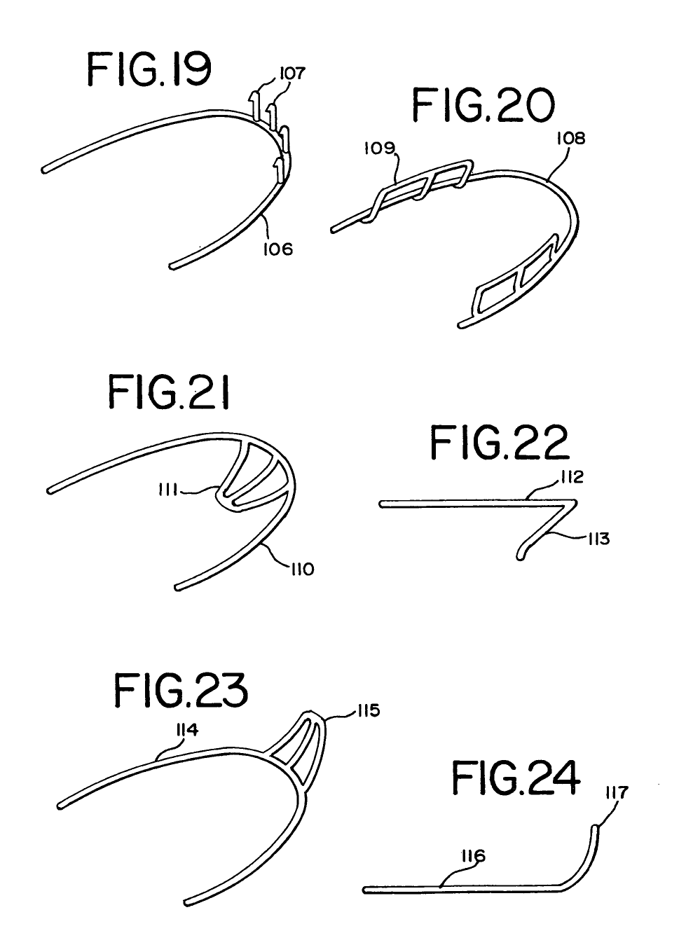

The prongs 101, the rake 103 and/or the roller 105 may correct and/or may prevent tongue-thrust swallowing patterns of and/or thumb sucking by the patient. A first tongue-thrust swallowing pattern may permit the tongue of the patient to be held forward in the lower arch of the patient which may spread and/or may labialize lower incisors of the patient. Wires 107 may be attached to a lower base wire 106 as illustrated in FIG. 19. The wires 107 may touch and/or may prevent the tongue from advancing against the lower incisors. The wires 107 may be attached to the lower base wire 106 via welding or soldering. Alternatively, a second tongue-thrust swallowing pattern may laterally thrust and/or may prevent free eruption of the posterior teeth of the patient. A wire attachment 109 may be integrally formed with the lower base wire 106 or to an upper base wire (not shown) to prevent the tongue of the patient from spreading laterally and from flowing or from squeezing between occlusal surfaces of the posterior teeth as illustrated in FIG. 20. The attachment 109 may be attached to an upper base wire (not shown in the drawings) or to a lower base wire 108 via welding or soldering.

FIG. 21 illustrates a lingual tab 111 which may be attached to a base wire 110. The base wire 110 may be an upper base wire or a lower base wire. The lingual tab 111 may encourage a lower jaw of the patient to be positioned forward with respect to an upper jaw of the patient. FIG. 22 illustrates a side view of the base wire 110 which has a lingual tab attached thereon. The lingual tab 111 may be attached to the base wire 110 by welding or soldering. Alternatively, acrylic, rubber, silicone and/or a plastic may be added to the tab 111 to fill in the spaces between the wires and to more closely adapt the tab to tissues and/or to an appliance. As a result, the lingual tab 111 may be adjusted to alter the position of the lower jaw.

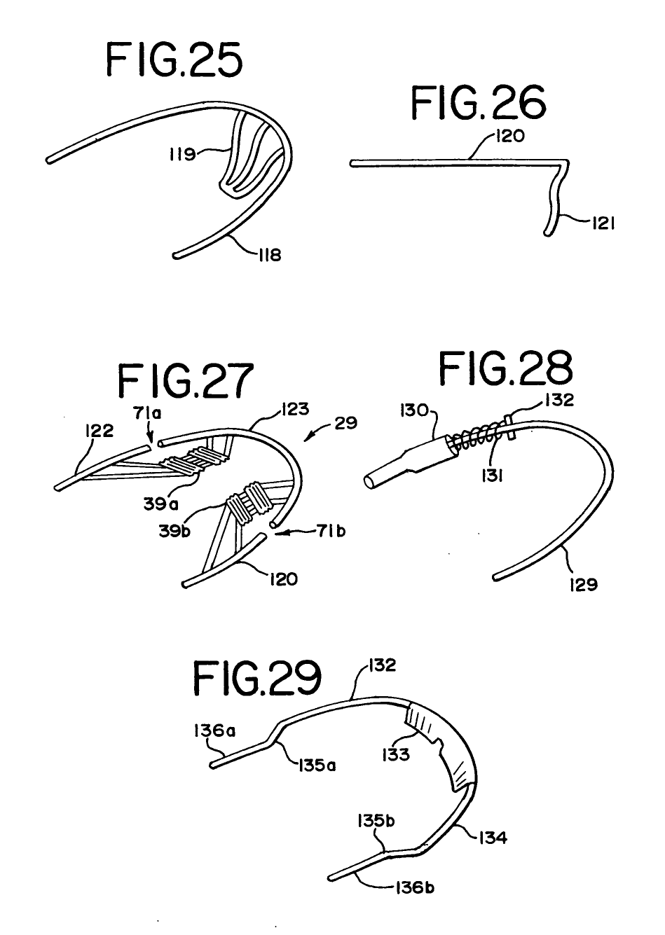

FIG. 23 illustrates a labial tab 115 which is attached to a bucco-labial base wire 114 of the lower appliance 10. The labial tab 115 may be labially positioned to the upper teeth which may hold the lower jaw in a forward position with respect to the upper jaw. A side view of the bucco-labial base wire 114 with the supporting wires of the labial tab 115 attached thereon is illustrated in FIG. 24. The acrylic, the rubber, the silicone and/or the plastic may be located between the labial tab 115. As a result, contact between the supporting wires of the labial tab 115 and the upper arch of the patient may be comfortable for the patient and afford adjustment of the lower jaw in relation to the upper jaw. FIG. 25 illustrates a labial tab 119 which may be attached to a bucco-labial base wire 118 to hold the lower jaw back in a retruded position with respect to the upper jaw. As a result, the labial tab 119 and the bucco-labial base wire 118 may correct and/or may prevent, for example, a Class III type malocclusion and/or protrusion of the lower jaw from developing. FIG. 26 illustrates a side view of the bucco-labial base wire 118 having the labial tab 119 attached thereon. The base wires 100, 106, 110, 114, 118 may be attached to the upper appliance 1 and/or the lower appliance 10. The base wires 100, 102, 104, 106, 108, 110, 114, 118 may be attached to the upper appliance 1 and/or the lower appliance 10 via molding, gluing, sealing with self-cure acrylic and/or the like. Alternatively, the base wires 100, 102, 104, 106, 108, 110, 114, 118 may be placed into the groove 5 and/or the groove 6 of the upper appliance 1 and/or the lower appliance 10, respectively.

FIG. 27 illustrates a base wire 29 which may have a first expansion split 71a and/or a second expansion split 71b. The base wire 29 may have a first screw attachment 39a which may correspond to the first expansion split 71a and/or a second screw attachment 39b which may correspond to the second expansion split 71b. The base wire 29 may open spaces along the dentition of the patient via the screw attachments 39a, 39b. For example, the base wire 29 may be separated into a first section 122, a second section 123 and/or a third section 124. As a result, the base wire 29 may create a space for canine teeth and/or any other teeth of the patient.

FIG. 28 illustrates a base wire 129 which may have a female sleeve 130 with a spring 131 and a stop 132. The spring 131 may be activated against the sleeve 130 to open a space and/or to distalize the dentition in a rear of the mouth of a patient and/or any other area of the dentition. The spring 131 may be activated to extend the base wire 129 outward and/or rearward with respect to the female sleeve 130. As a result, the base wire 129 and the female sleeve 130 may open the space in the dentition of the patient. FIG. 29 illustrates a base wire 134 which may engage and/or may attach to the upper appliance 1 and/or the lower appliance 10. The base wire 134 may be engaged at ends 136a, 136b in the buccal surface of the upper appliance 1 and/or the lower appliance 10. The base wire 134 may extend outward with respect to the upper appliance 1 and/or the lower appliance 10 at positions 135a, 135b. The base wire 134 may have a labial shield 133 attached thereon which may distalize the posterior teeth. The upper appliance 1 and/or the lower appliance 10 may be separated at the positions 135a, 135b and/or the ends 136a, 136b, respectively, to provide a space located within the arch of the upper jaw and/or within the arch of the lower jaw of the patient.

FIG. 30 illustrates a bucco-labial base wire 137 which may have attachments 138a, 138b thereon. The attachments 138a, 138b may have stops 139a, 139b, respectively, and/or springs 140a, 140b, respectively. The attachments 138a, 138b may insert into buccal tubes attached to molars in the mouth (not shown) of the patient. The springs 140a, 140b may abut the stops 139a, 139b, respectively. As a result, molar teeth of the patient may be moved distally. Alternatively, attachments 142a, 142b may be connected to a lingual base wire 141 as illustrated in FIG. 31. The attachments 142a, 142b may have springs 143a, 143b, respectively, and/or stops 144a, 144b, respectively. Alternatively, lingual tubes 145a, 145b attached to the molars in the mouth of the patient may receive attachments 142a, 142b, respectively. As a result, the lingual base wire 141 may be embedded into the upper appliance 1 and/or the lower appliance 10 and/or the appliance 70 as illustrated in FIG. 32 and/or into the appliance 210 as illustrated in FIG. 52. Alternatively, the lingual base wire 141 may be attached to and/or may extend outward with respect to the upper appliance 1, the lower appliance 10 and/or the appliance 149 as illustrated in FIG. 32.

FIG. 33 illustrates a lingual tab 150 which may be integrally molded with the upper appliance 151. The upper appliance 151 may be constructed similarly to the upper appliance 1 and/or the appliance 70. The lingual tab 150 may extend downward with respect to the upper appliance 151 to maintain the lower jaw of the patient in a forward position with respect to the upper jaw of the patient. FIG. 34 illustrates a side view of the upper appliance 151 which may have the lingual tab 151 and a lower appliance 152. The lower appliance 152 may be constructed similarly to the lower appliance 10. The lingual tab 150 may extend downward with respect to the lower appliance 152. Alternatively, a lingual tab 153 and/or a labial tab (not shown) may be attached to an appliance 154 as illustrated in FIGS. 35 and 36. The appliance 154 may be constructed similar to the upper appliance 1 or the lower appliance 10. The lingual tab 153 and/or the labial tab (not shown) may be attached to the appliance 154 via the bond, the adhesive, the paste and/or the like. The appliance 154 may have a groove 250 which may be preformed and/or may be sized to receive the upper teeth and/or the lower teeth of the patient. FIG. 37 illustrates a side view of the lingual tab 153.

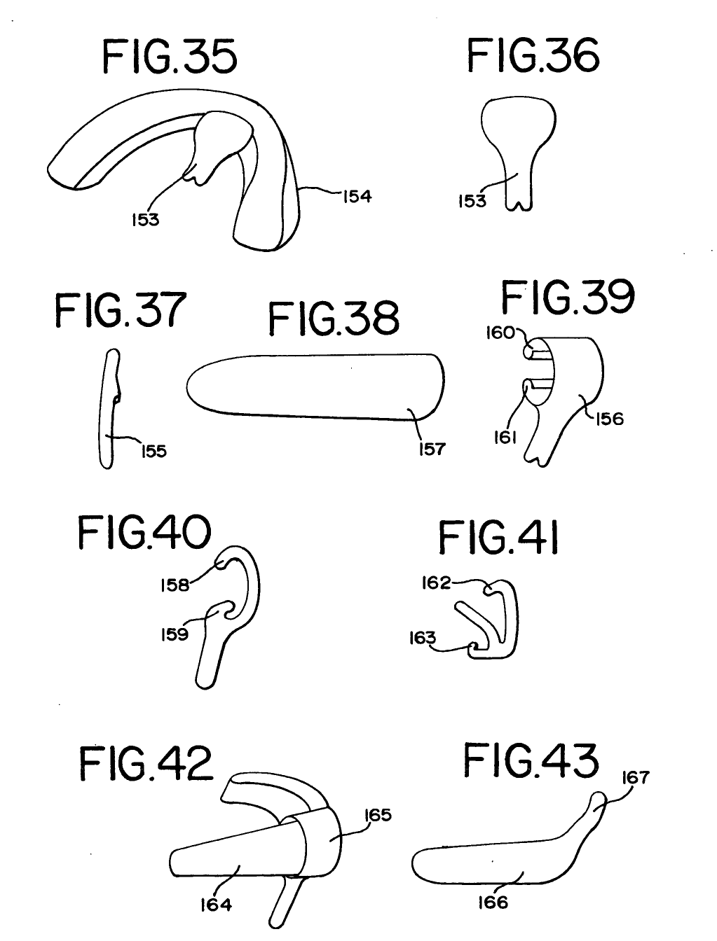

FIGS. 38-41 illustrate a lingual tab 156 which may attach to an upper appliance 157. The upper appliance 157 may be constructed similar to the upper appliance 1 or the appliance 70. The lingual tab 156 may be removably attached to the upper appliance 157. The lingual tab 156 may be placed onto the upper appliance 157 via a first undercut 162 and/or a second undercut 163 of the upper appliance 157 with hooks 160, 161 of the lingual tab 156. The hooks 160, 161 may be integrally formed with the lingual tab 156. As a result, the lingual tab 156 may be attached to the upper appliance 157 as shown in FIG. 42. Alternatively, the lingual tab 156 may be permanently attached to the upper appliance 157 via the bonding, the adhesive and/or the like or injection molded combining the tab 156 and the upper appliance 157 as a single unit.

FIG. 43 illustrates a side view of a labial tab 167 which may be integrally molded with a lower appliance 166. The lower appliance 166 may be constructed similar to the lower appliance 10 or the appliance 70. FIG. 44 illustrates a cross-sectional view of the lower appliance 166, 168 and the labial tab 167, 169 which may maintain the jaw in a forward position with respect to the upper appliance 170.

FIG. 45 illustrates a lower appliance 171 which may collapse behind a lingual surface 28 of an upper appliance 172. The lower appliance 171 and the upper appliance 172 may be constructed similar to the lower appliance 10 and the upper appliance 1, respectively. An upper appliance 173 may be molded with a shelf 174 thereon to abut a lower appliance 175 from as shown in FIG. 46. The lower appliance 175 may be molded with a shelf 176 as illustrated in FIG. 46. The upper appliance 173 and/or the lower appliance 175 may be constructed similar to the upper appliance 1 and/or the lower appliance 10, respectively. As a result, overjetting and/or misalignment of the upper appliance 173 and/or the lower appliance 175 may be prevented via the shelf 174 and/or the shelf 176. The shelves 174, 176 may be located at a front section and/or a rear section of the upper appliance 173 and/or the lower appliance 175, respectively. The shelves 174, 176 may be integrally formed with the upper appliance 173 and the lower appliance 175, respectively.

Each of the base wires 20, 31, 45, 61, 63, 91, 100, 102, 104, 106, 108, 110, 114, 116, 118, 120, 122, 129, 134, 137, 141, 148, 196, 198, 212a, 212b may apply a force which may expand and/or may constrict each of the lower appliances 10, 70, 149, 154, 166, 168, 171, 175, 193, 201, 220 and/or each of the upper appliances 1, 70, 149, 150, 154, 157, 164, 170, 172, 173, 192, 200, 220. Each of the base wires 20, 31, 45, 61, 63, 91, 100, 102, 104, 106, 108, 110, 114, 116, 118, 120, 122, 129, 134, 137, 141, 148, 196, 198, 212a, 212b may depress and/or may erupt sections of the first arch and/or the second arch. Any of the base wires discussed herein may be embedded into the appliances 1, 10, 70, 149, 150, 151, 152, 154, 157, 164, 166, 168, 170, 171, 172, 173, 175, 192, 193, 200, 220, 229, 234 on the lingual surface as shown in FIGS. 1-4 and 14, 15 and 52 and/or with the wire 92 on the bucco-labial surface and/or the labial surface as shown in FIG. 15.

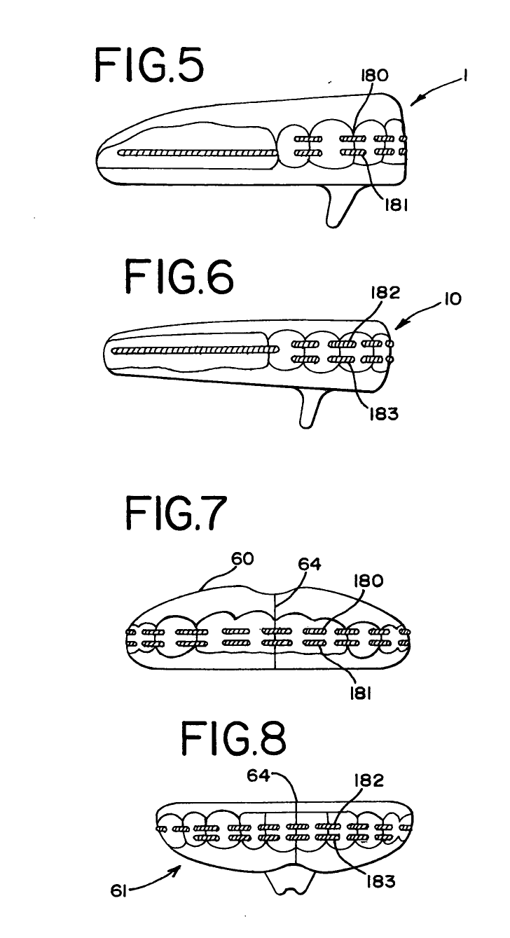

FIGS. 5-8 illustrate an upper appliance 60 and a lower appliance 61, respectively. The upper appliance 60 may be constructed similar to the upper appliance 1. The upper appliance 60 may have ribs 180, 181 as shown in FIGS. 5 and 7. The ribs 180, 181 may be integrally formed with the upper appliance 60. The lower appliance 61 may be constructed similar to the lower appliance 10. The lower appliance 61 may have ribs 182, 183 as shown in FIGS. 6 and 8. The ribs 182, 183 may be integrally formed with the lower appliance 61. The upper appliance 60 and/or the lower appliance 61 may have a midline 64 as illustrated in FIGS. 7 and 8. The ribs 180-183 may be constructed similar to labial ribs 184, 185, 186, 187 and lingual ribs 188, 189, 190, 191 of an upper appliance 192 and a lower appliance 193, respectively, as shown in FIG. 47. The labial ribs 184-187 and/or the lingual ribs 188-191 may contact and/or may move the teeth of the patient. The labial ribs 184, 187 and/or the lingual ribs 188, 191 may contact erupting teeth and/or may move the erupting teeth. The labial ribs 185, 189 and the lingual ribs 186, 190 may contact and/or may move fully erupted teeth of the patient. The ribs 184-191 may be selectively removed by snipping with a ligature cutter. The ribs 184-191 may be slanted with a ramp towards the gingival 178 or towards the incisal 179 to facilitate uninterrupted eruption.

For example, the ribs 185, 189, 186, 190 may abut, may contact and/or may move one or more teeth of the patient in a first direction. The ribs 184, 187, 188, 191 may be removed to allow one or more teeth to move further in the first direction without hindrance that may be caused by the ribs 184, 187, 188, 191. The lingual ribs 189, 190 may remain in the upper appliance 192 and the lower appliance 193, respectively. The lingual ribs 188, 191 may be removed from the upper appliance 192 and the lower appliance 193 to apply a lingual root torque to one or more of the teeth. Movements of one or more teeth in one or more directions, respectively, may be accomplished by selectively keeping or selectively removing one or more ribs 184-191 within the upper appliance 192 and/or the lower appliance 193.

FIGS. 48 and 49 illustrate the upper appliance 192 and/or the lower appliance 193 which may be narrowed for teeth 195, 194, respectively, of the patient. As a result, a pressure and/or a force may be applied to the teeth 194, 195 of the patient moved by ribs 184-191 which may exert a force on the teeth 194, 195 of the patient. The ribs 190, 191 may be located in mesial and/or distal areas of the teeth of the patient or continuously across all teeth in the dentition.

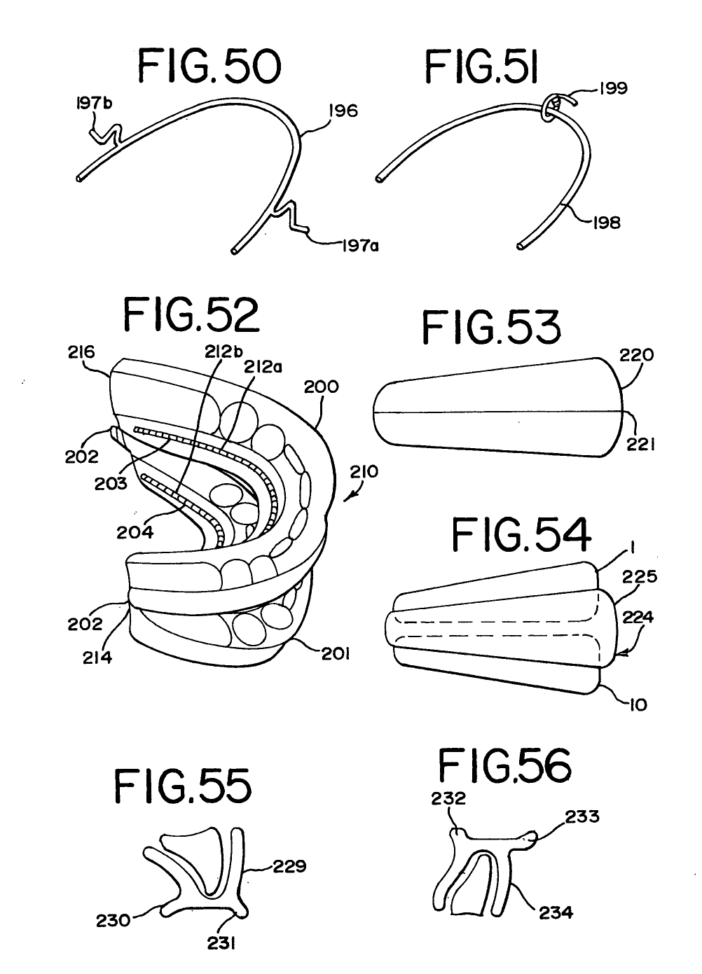

FIG. 50 illustrates a base wire 196 which may have finger spring attachments 197a, 197b thereon. The finger spring attachments 197a, 197b may be integrally formed with the base wire 196. The finger spring attachments 197a, 197b may abut and/or may contact one or more teeth of the patient. The finger spring attachments 197a, 197b may exert a force on one or more teeth of the patient. As a result, the finger spring attachments 197a, 197b may move one or more teeth of the patient to open and/or to close space between the teeth. Additional finger spring attachments (not shown in the drawings) may be integrally formed with the base wire 196 to move one or more teeth of the patient. FIG. 51 illustrates a base wire 198 which may have an attachable finger spring 199 thereon. The finger spring 199 may move one or more teeth of the patient. The finger spring attachments 197a, 197b and/or the finger spring 199 may be attached to labio-buccal wires and/or lingual wires to move one or more teeth of the patient in one or more directions in the mouth of the patient.

FIG. 52 illustrates a double appliance 210 which may have an upper appliance 200 which may be connected and/or may be attached to a lower appliance 201. The upper appliance 200 may be constructed similar to the upper appliance 1 or the appliance 70. The lower appliance may be constructed similar to the lower appliance 10 or the appliance 70. The upper appliance 200 may be connected to the lower appliance 201 with a hinge 202. The hinge 202 may be attached to the lower appliance 201 at a rear end 214 via the bond, the adhesive, a screw, a pin or molded integrally into the appliance and/or the like. The hinge 202 may be attached to the upper appliance 200 at a rear end 216 via the bond, the adhesive, the screw, the pin or molded and/or the like. Alternatively, the upper appliance 200 and the lower appliance 201 may be linked to one another by, for example, wedges, springs, guides and/or the like.

The double appliance 210 may be prefabricated to receive one or more teeth of the patient and/or may be custom molded for the patient to receive the dentition and/or the teeth of the patient. The double appliance 210 may be custom molded based on models of the dentition of the patient, digitized images of the dentition by vacuum forming, stereolithography and/or the like. The double appliance 210 may be custom molded for the patient to have sockets to receive one or more teeth of the patient and/or preformed to have sockets to receive one or more teeth of the patient. The double appliance 210 may have the posterior slot 7, rear sockets 3 and/or the front sockets 4 to receive one or more teeth of the patient.

Grooves 203, 204 may be molded into the appliances 200, 201, respectively, to receive base wires 212a, 212b. The base wires 212a, 212b may be constructed similarly to any of the base wires as discussed herein. The base wires 212a, 212b may be inserted and/or may be placed into the groove 203 and/or the groove 204, respectively or on the bucco-lingial 92 in the lower appliance 10, 201 or on the bucco-labial (not shown) of the upper appliance 1, 200. The base wires 212 may be affixed to the upper appliance 200 and/or the lower appliance 201 by bonding, adhering and/or the like. For example, the groove 203 may be coated with the primer and the base wire 212 may be inserted into the groove 203. As a result, the groove 203 may be sealed with a reliner such as the self-cure acrylic to adhere the base wire 212 to the groove 203. The base wire 212 may be bent by expanding and/or by constricting of the base wire 212. The base wire 212 may be bent with respect to the double appliance 210 from a front position to a rear position to depress and/or to erupt various teeth and/or groups of teeth of the patient.

The upper orthodontic appliance 1 and/or the lower orthodontic appliance 10 may secure to a first area of the dentition and/or may move the teeth at a second area of the dentition. The upper appliance 1 and/or the lower appliance 10 may have the posterior slot 7 and/or the rear sockets 3 to secure to the appliance to the dentition of the patient. The upper appliance 1 and/or the lower appliance 10 may have the rear sockets 3 and/or the front sockets 4 to move the teeth and/or to correct the orthodontic condition of the patient. The upper appliance 1 and/or the lower appliance 10 may be preformed to receive the teeth of the patient, may be custom molded to receive the teeth of the patient or may be both preformed and custom molded to receive the teeth of the patient. The rear sockets 3, the front sockets 4 and/or posterior slot 7 may receive one or more teeth of the patient to secure the upper appliance 1 and/or the lower appliance 10 to the teeth of the patient.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A dental appliance worn on a dentition of a mouth of a user wherein the dentition has a first tooth and a second tooth, the dental appliance comprising:
a generally U-shaped base sized to receive the dentition of the user wherein the generally U-shaped base has a first portion and a second portion wherein the first portion receives the first tooth wherein the first portion of the generally U-shaped base is attached to the mouth of the user via the first tooth and a material located between the second portion of the generally U-shaped base and the first tooth wherein the second portion of the generally U-shaped base moves the second tooth of the user.

2. The dental appliance of claim 1 wherein the material is a reline material.

3. The dental appliance of claim 1 wherein the material is an adhesive or a glue.

4. The dental appliance of claim 1 wherein the material is heated prior to insertion between the generally U-shaped base and the first tooth.

5. The dental appliance of claim 1 wherein the material hardens to secure the generally U-shaped base to the mouth of the user.

6. The dental appliance of claim 1 wherein the first portion or the second portion of the generally U-shaped base is preformed or customized or both preformed and customized.

7. The dental appliance of claim 1 further comprising:
an opening formed in the generally U-shaped base for receiving the first tooth, the second tooth or more than two teeth of the dentition.

8. The dental appliance of claim 1 wherein the generally U-shaped base guides an erupting tooth of the user into the mouth of the user.

9. The dental appliance of claim 1 wherein the first portion of the generally U-shaped base is constructed from a first material and the second portion of the base is constructed from a second material wherein the first material is stiffer than the second material.

10. The dental appliance of claim 1 further comprising:
a reline material insertable between the second tooth and the second portion of the generally U-shaped base.

11. The dental appliance of claim 1 wherein the dentition is a deciduous or a permanent or both deciduous and permanent.

12. A dental appliance worn in a mouth of a user wherein the mouth of the user has a dentition having a first tooth and a second tooth, the dental appliance comprising:
a generally U-shaped base having an interior surface and an exterior surface wherein the generally U-shaped base is sized to receive the dentition of the user wherein the interior surface of the generally U-shaped base has a first portion and a second portion wherein the interior surface contacts the dentition wherein the first portion of the generally U-shaped base receives the first tooth of the dentition wherein the generally U-shaped base is constructed from a first material and further wherein the first portion of the generally U-shaped base is attached to the dentition of the user via the first tooth; and
an elevation attached on the second portion of the interior of the generally U-shaped base wherein the elevation extends outward with respect to the interior of the generally U-shaped base wherein the elevation contacts the second tooth of the dentition and further wherein the elevation moves the second tooth.

13. The dental appliance of claim 12 wherein the elevation is integrally formed with the generally U-shaped base.

14. The dental appliance of claim 12 wherein the elevation is constructed from a second material wherein the second material is softer than the first material.

15. The dental appliance of claim 12 wherein the elevation extends into a labial area, a buccal area or a lingual area of the mouth of the user.

16. The dental appliance of claim 12 wherein the elevation applies a pressure to the second tooth to move the second tooth.

17. The dental appliance of claim 12 further comprising:
an opening formed in the generally U-shaped base for receiving the first tooth, the second tooth or more than two teeth of the dentition.

18. The dental appliance of claim 12 wherein the generally U-shaped base guides an erupting tooth of the user into the mouth of the user.

19. The dental appliance of claim 12 further comprising:
a reline material insertable between the second tooth and the generally U-shaped base.

20. The dental appliance of claim 12 wherein the first portion or the second portion of the generally U-shaped base is preformed, customized or both preformed and customized.

21. The dental appliance of claim 12 wherein the dentition is deciduous or permanent or both deciduous and permanent.

22. A dental appliance worn on a dentition in a mouth of a user wherein the dentition has an orthodontic condition, the dental appliance comprising:
a generally U-shaped base having a length defined between a first end and a second end wherein the generally U-shaped base is sized to receive the dentition of the mouth of the user wherein the generally U-shaped base has a first portion and a second portion wherein the first portion of the generally U-shaped base receives a first tooth of the dentition and further wherein the first portion of the generally U-shaped base is attached to the dentition via the first tooth; and
a first wire imbedded in the generally U-shaped base wherein the first wire extends from the first end to a point along the length of the generally U-shaped base wherein the first wire moves a second tooth of the dentition wherein the first wire corrects the orthodontic condition of the dentition.

23. The dental appliance of claim 22 wherein a break in the first wire separates the first wire into a first portion and a second portion.

24. The dental appliance of claim 22 further comprising:
a screw attached to the first wire wherein the screw connects the first end of the generally U-shaped base to the second end of the generally U-shaped base.

25. The dental appliance of claim 22 further comprising:
a second wire attached to the first wire.

26. The dental appliance of claim 22 wherein the orthodontic condition is a rotation, a sliding movement, thumb sucking, tongue thrust swallowing, a tongue habit, an expansion of an arch or a distalized tooth.

27. The dental appliance of claim 22 wherein the second portion of the generally U-shaped base moves the second tooth of the dentition.

28. The dental appliance of claim 22 further comprising:
an opening formed in the generally U-shaped base for receiving the first tooth, the second tooth or more than two teeth of the dentition.

29. The dental appliance of claim 22 wherein the generally U-shaped base guides an erupting tooth of the user into the mouth of the user.

30. The dental appliance of claim 22 further comprising:
a reline material insertable between the second tooth and the generally U-shaped base.

31. The dental appliance of claim 22 wherein the first portion or the second portion of the generally U-shaped base is preformed, customized or both preformed and customized.

32. The dental appliance of claim 22 wherein the dentition is deciduous, permanent or both deciduous and permanent.

33. The dental appliance of claim 22 wherein the first portion of the generally U-shaped base is constructed from a first material and the second portion of the generally U-shaped base is constructed from a second material wherein the first material is stiffer than the second material.

34. A system for correcting an orthodontic condition of a mouth of a user wherein the mouth of the user has a first dentition attached to a first jaw of the user and a second dentition attached to an second jaw of the user, the system comprising:
a first dental appliance sized to receive the first dentition of the first jaw wherein the first dental appliance has a first portion and a second portion wherein the first dental appliance receives a first tooth of the first dentition and further wherein the first portion of the first dental appliance is attached to the upper jaw via the first tooth of the first dentition;
a second dental appliance sized to receive the second dentition of the second jaw wherein the second dental appliance has a first portion and a second portion wherein the second dental appliance receives a first tooth of the second dentition and further wherein the first portion of the second dental appliance is attached to the second jaw via the first tooth of the second dentition; and
a fastening means attaching the first dental appliance and the second appliance wherein the first dental appliance and the second dental appliance is worn by the user and further wherein the second portion of the first dental appliance or the second portion of the second dental appliance corrects the orthodontic condition of the mouth of the user.

35. The system of claim 34 wherein the fastening means is a hinge, a wedge, a rim, a border, a guide, an incline, an overlay or a shell.

36. The system of claim 34 further comprising:
an opening formed in the first dental appliance or the second dental appliance.

37. The system of claim 34 wherein the base guides an erupting tooth of the user into the mouth of the user.

38. The dental appliance of claim 34 wherein the first portion or the second portion of the first dental appliance or the second dental appliance is preformed or customized or both preformed and customized.

39. The dental appliance of claim 34 wherein the first dentition or the second dentition is deciduous or permanent or both deciduous and permanent.

40. A dental appliance worn in the mouth of a user wherein the mouth of the user has a first jaw having a dentition and a second jaw opposite to the first jaw wherein the dentition has a first tooth and a second tooth wherein the second jaw is in a first position with respect to the first jaw wherein the mouth of the user has an orthodontic condition based on the first position of the second jaw, the dental appliance comprising:
a generally U-shaped base sized to receive the first dentition of the first jaw wherein the generally U-shaped base has an exterior surface for contacting the mouth of the user wherein the generally U-shaped base has a first portion and a second portion wherein the first portion receives the first tooth of the first dentition wherein the first portion of the generally U-shaped base is attached to the first jaw via the first tooth of the first dentition; and
a tab attached to the exterior surface of the generally U-shaped base wherein the tab extends outward with respect to the exterior surface of the generally U-shaped base wherein the tab moves the second jaw to a second position with respect to the first jaw wherein the tab corrects the orthodontic condition.

41. The dental appliance of claim 40 wherein the tab maintains the second jaw in the second position with respect to the first jaw.

42. The dental appliance of claim 40 wherein the tab is attached to the generally U-shaped base via a snap or an adhesive.

43. The dental appliance of claim 40 wherein the tab is integrally formed in the generally U-shaped base.

44. The dental appliance of claim 40 wherein the second position of the second jaw is positioned in a rearward direction or in a forward direction with respect to the first position of the second jaw of the mouth of the user.

45. The dental appliance of claim 40 further comprising:
an opening formed in the generally U-shaped base for receiving the dentition of the first jaw.

46. The dental appliance of claim 40 wherein the base guides an erupting tooth into the mouth of the user.

47. The dental appliance of claim 40 wherein the first portion or the second portion of the generally U-shaped base is preformed or customized or both preformed and customized.

48. The dental appliance of claim 40 wherein the first dentition is deciduous or permanent or both deciduous and permanent.

49. The dental appliance of claim 40 wherein the second portion of the generally U-shaped base moves the second tooth of the dentition.

50. The dental appliance of claim 40 further comprising:
a reline material insertable between the second tooth and the base.

51. The dental appliance of claim 40 wherein the first portion of the generally U-shaped base is constructed from a first material and the second portion of the generally U-shaped base is constructed from a second material wherein the first material is stiffer than the second material.
